(19) United States
(12) Patent Application Publication
(10) Pub. No.: US 2010/0241498 A1
(43) Pub. Date: Sep. 23, 2010

(54) DYNAMIC ADVERTISING PLATFORM

(75) Inventors: Wook Jin CHUNG, Krikland, WA (US); Hrishikesh Mohan BAL, Bellevue, WA (US); Michael Lee LORITSCH, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/407,640

(22) Filed: Mar. 19, 2009

(51) Int. Cl. G06Q 30/00; G06Q 99/00; G06F 15/16; G06F 7/10; G06F 17/30

(52) U.S. Cl. 705/14.5; 705/10; 715/762; 707/E17.108

(57) ABSTRACT

Computer-readable media and computer systems for managing an ad campaign based on foreseeable, but not necessarily certain future events. An advertiser can configure a campaign trigger definition corresponding to an advertising campaign such that upon occurrence of a trigger event defined therein, an operation is performed corresponding to the campaign. A crawler references the campaign trigger definition and identifies information sources from which to retrieve information about a specified trigger event. Upon retrieving event information, an analysis module determines whether the information indicates an occurrence of the trigger event. Incident to identifying an occurrence of a trigger event, an ad campaign can be initiated or modified.

### BACKGROUND

Advertisers always strive to find an optimal set of consumers. To meet this need, advertising platforms often provide targeting parameters such as age group, gender, physical location, income level, time of day, and the like. These parameters can be helpful for targeting advertisements to individuals or persons classifiable by some predetermined parameter, but are less helpful for targeting advertisements to dynamically changing optimum target audiences, especially those that correspond to social events, social trends, economic events, economic trends, natural disasters, changes in spending power of a region, fluctuations in financial markets, fluctuations in employment markets, scheduled holidays, scheduled or conditional injections of cash into local economies, and the like. Moreover, immediate modification of advertising campaigns based on occurrences of future foreseeable, but not necessarily guaranteed, events such as these is not supportable by conventional advertisement platforms, which depend on decision-making and other inputs from individuals only after the event has occurred.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the invention generally relate to computer-readable media and a computer system for managing advertisement campaigns. In embodiments, advertisers interact with an interface to configure advertising (“ad”) campaigns. In embodiments, ad campaigns can be configured according to parameters supplied by the advertisers. A set of parameters supplied by an advertiser can, according to some embodiments, comprise a campaign trigger definition that includes an identification of a campaign trigger. A campaign trigger can include an event, the occurrence of which causes an initiation or modification of an ad campaign. Events can include any number of types of social, economic, physical, or political events, changes in trends associated with consumer behaviors, natural disasters, changes in values of stocks traded on stock markets, changes in prices of particular consumer goods or services, injections of cash into local economies, increases or decreases in spending power associated with members of a community or region, results of sporting events, results of political elections, updates in news reports, and the like.

According to embodiments of the invention, an ad network hosts a trend/event crawler that is configured to retrieve event information corresponding to campaign triggers identified in campaign trigger definitions. In embodiments, event information can be retrieved from a number of different sources, and to improve accuracy and reliability, a weighting system can be implemented based on the types of sources that are accessed. When event information identifies an occurrence of a trigger event, the ad network can perform some operation on an associated ad campaign. For example, in some embodiments, a trigger event causes the initiation of an ad campaign (e.g., delivery of one or more advertisements) and in other embodiments, a trigger event results in a modification or termination of an ad campaign.

Accordingly, embodiments of the invention exploit the immediate availability of information related to events such as social events, economic events, natural events, and the like to retrieve, aggregate, and analyze event information. When event information identifies an occurrence of a campaign trigger event, an ad campaign is initiated or modified. In embodiments, an operation is performed on the campaign incident to identifying an occurrence of a trigger event. The operation can include, for example, initiating an ad campaign, delivering an ad, modifying an ad campaign trigger definition element, adjusting a bid on ad inventory, adjusting a budgeted amount associated with a particular ad campaign, terminating an ad campaign, customizing ad content based on the trigger event, modifying the contextual relevance of the ad content based on the trigger event, and the like. Various features of the invention can be configured by the advertiser to allow for customization of the ad campaign management experience described herein.

### BRIEF DESCRIPTION OF THE DRAWINGS

Embodiments of the inventions are described in detail below with reference to the attached drawing figures, wherein:

FIG. 1 is a schematic diagram of an exemplary implementation of an embodiment of the invention;

FIG. 2 is a schematic diagram of an exemplary system architecture suitable for use in implementing embodiments of the invention;

FIG. 3A depicts an illustrative example of a campaign trigger definition in accordance with embodiments of the invention;

FIG. 3B depicts another illustrative example of a campaign trigger definition in accordance with embodiments of the invention;

FIG. 3C depicts a further illustrative example of a campaign trigger definition in accordance with embodiments of the invention;

FIG. 4 is a schematic diagram of an illustrative subset of processing steps performed within an exemplary system architecture, in accordance with embodiments of the invention;

FIG. 5 is a flow diagram illustrating an exemplary method of managing an advertising campaign in accordance with embodiments of the invention; and

FIG. 6 is another flow diagram illustrating an exemplary method of managing an advertising campaign in accordance with embodiments of the invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention described herein include systems and methods for managing an ad campaign. In a first illustrative embodiment, a set of computer-executable instructions provides an exemplary method of managing an advertising campaign. Embodiments of the exemplary method include receiving a campaign trigger definition corresponding to an advertising campaign. The trigger definition is referenced and an information source is identified. Event information is retrieved from the information source and analyzed to determine whether the event information identifies an occurrence of a trigger event. In embodiments, an operation corresponding to the advertising campaign is performed incident to identifying the occurrence of the trigger event.

In a second illustrative embodiment, a set of computer-executable instructions provides an exemplary method of managing an advertising campaign. Embodiments of the exemplary method include referencing a campaign trigger definition corresponding to an advertising campaign. In embodiments, an event occurrence vote can be retrieved from each of one or more information sources. A weighting factor corresponding to each of the information sources can be referenced and associated with the corresponding event occurrence votes to create weighted votes. The weighted votes are analyzed to determine whether an occurrence of a trigger event is identified. Incident to identification of a trigger event, embodiments of the exemplary method further include performing an operation corresponding to the advertising campaign.

In a third illustrative embodiment, a computer system is provided that is capable of causing an advertisement to be provided to a presentation device. In embodiments, the computer system includes a storage medium having a number of software modules embodied thereon. When executed by a processor, the modules include a user interface that allows an advertiser to configure a campaign trigger definition associated with an advertising campaign, a crawler that retrieves event information associated with trigger events defined within the campaign trigger definition from one or more information sources, and an analysis module that analyzes the event information to determine whether an occurrence of the trigger event is identified by the event information. According to various embodiments, the exemplary computer system further includes a delivery engine that causes an advertisement corresponding to the advertising campaign to be displayed via the presentation device.

Embodiments of the invention may be described in the general context of computer code or machine-useable instructions, including computer-executable instructions such as program components or software modules, being executed by a computer, laptop, or other machine, such as a personal data assistant, wireless device, or other handheld device. Generally, program components including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the inventions may also be practiced in distributed computing environments where tasks are performed by remote-processing devices that are linked through a communications network.

An exemplary computing device useful for implementation of embodiments of the invention includes a bus that directly or indirectly couples the following devices: memory, one or more processors, one or more presentation components, input/output (I/O) ports, I/O components, and an illustrative power supply. Although the various components of an exemplary computing device are clearly distinguished in this description for the sake of clarity, in reality, delineating various components is not so clear. For example, one may consider a presentation component such as a display device to be an I/O component. Also, processors have memory. The inventors recognize that such is the nature of the art and reiterate that this description is illustrative of an exemplary computing device that can be used in connection with one or more embodiments of the inventions disclosed herein. Distinction is not made between such categories as “workstation,” “server,” “laptop,” “handheld device,” “mobile device,” “wireless device,” etc., as all are contemplated to be within the scope of the invention with reference to “computer” or “computing device.”

An exemplary computing device typically includes a variety of computer-readable media. By way of example, and not limitation, computer-readable media may comprise computer-storage media such as Random Access Memory (RAM); Read Only Memory (ROM); Electronically Erasable Programmable Read Only Memory (EEPROM); flash memory or other memory technologies; Compact Disc Read-Only Memory (CD-ROM), digital versatile disks (DVDs) or other optical or holographic media; magnetic cassettes, magnetic tape, magnetic disk storage or other magnetic storage devices; or any other medium that can be used to encode information and can be accessed by a computing device.

Memory includes computer-storage media in the form of volatile and/or nonvolatile memory. The memory may be removable, nonremovable, or a combination thereof. Exemplary hardware devices include solid-state memory, hard drives, optical-disc drives, etc. An exemplary computing device includes one or more processors that read data from various entities such as memory or I/O components. Presentation component(s) present data indications to a user, advertiser, or other device. Exemplary presentation components include a display device, speaker, printing component, vibrating component, etc. I/O ports allow a computing device to be logically coupled to other devices including I/O components, some of which may be built in. Illustrative I/O components include a microphone, joystick, game pad, satellite dish, scanner, printer, wireless device, keyboard, pen, voice-input device, touch-input device, touch-screen device, interactive display device, and a mouse.

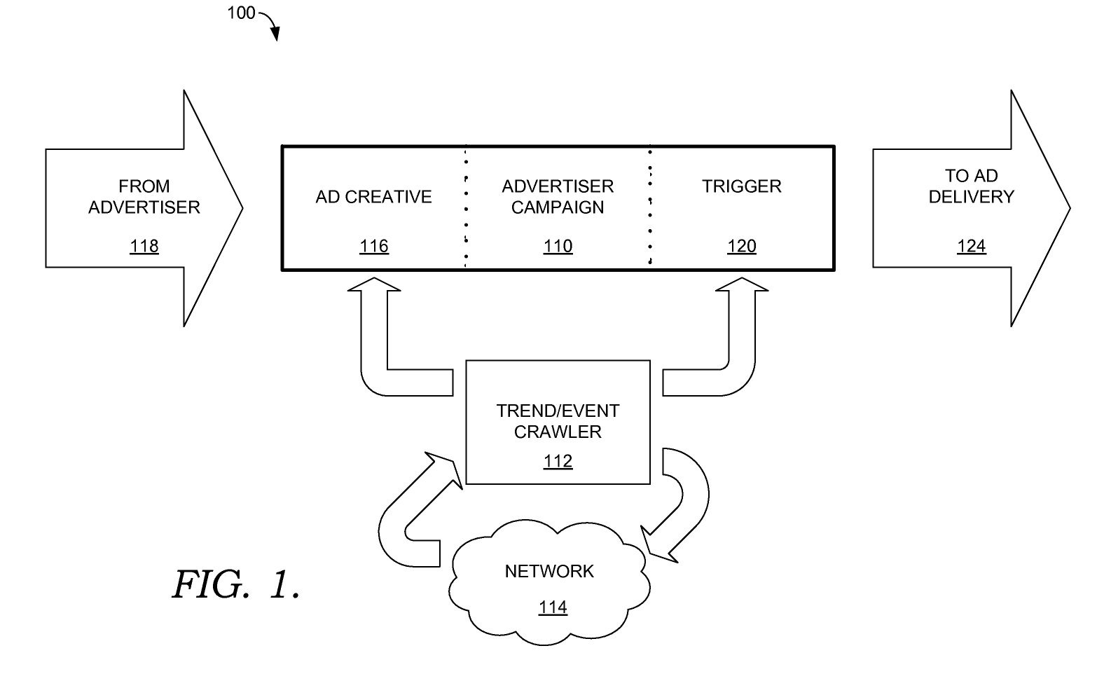

Referring now to the drawings, and initially to FIG. 1, a schematic diagram of an exemplary implementation of an embodiment of the invention is shown. The exemplary implementation includes an advertising campaign 110, a trend/event crawler 112, and a network 114. The exemplary implementation shown in FIG. 1 is an example of one suitable implementation and is not intended to suggest any limitation as to the scope of use or functionality of embodiments of the inventions disclosed throughout this document. Neither should the exemplary implementation 100 be interpreted as having any dependency or requirement related to any single component or combination of components illustrated therein. Furthermore, embodiments of inventions disclosed herein can be integrated with any type of advertising platform. For example, in addition to online text and display advertising campaigns, many of the features described herein can be implemented with other types of advertising platforms such as radio, television, magazines, electronic billboards, and the like.

With reference to FIG. 1, advertising campaign 110 is created and modified by an ad creative process 116. According to some embodiments, the ad creative process 116 can include, for example, creating advertising content, configuring ad presentations and experiences, receiving campaign trigger definition parameters from the advertiser 118, and the like. Additionally, event information, consumer feedback information, consumer click-through rates, consumer satisfaction indications, budget changes, and the like can be used to configure and modify ad campaigns. According to some embodiments, trend/event crawler 112 is configured to retrieve event information corresponding to trigger events identified in ad campaign trigger definitions. Event information can be retrieved from databases, other data storage modules, advertisers, consumers, or other information sources, some of which may be accessed by way of one or more networks 114. In various embodiments, network 114 can be any kind of suitable network such as, for example, a local area network (LAN), a wide area network (WAN), the Internet, a cellular network, a peer-to-peer (P2P) network, or a combination of networks. This way, trend/event crawler can access and retrieve information from any number of different information sources.

In some embodiments, trend/event crawler 112 receives instructions to retrieve event information. In other embodiments, trend/event crawler 112 retrieves event information continuously or according to predetermined or dynamic schedules. Trend/event crawler 112 can retrieve information according to parameters included within an ad campaign trigger definition, according to embodiments. Crawler 112 can be configured to crawl websites providing event information about current events. Some types of current events that can be monitored by crawler 112 can include news, stock information, blogs, entertainment, and the like. In addition, crawler 112 can be configured to retrieve information from advertiser-specified websites, databases, or other sources.

The frequency with which crawler 112 crawls information sources to retrieve event information is configurable. In some embodiments, crawler 112 is configured to crawl for certain types of event information at a predetermined rate. In other embodiments, a campaign trigger definition can include among its trigger elements parameters that indicate how often crawler 112 should retrieve information. In further embodiments, parameters in a campaign trigger definition can specify information sources to access, types of information sources to access, and the like. Crawler 112 can, according to some embodiments, traverse content to search for keywords, events, breaking news, and even the general sentiment of the content. Moreover, fixed events such as holidays and cash bonus dates associated with certain companies can be entered into a database by an advertiser, retrieved from information sources, or otherwise provided to the system.

Event information retrieved by trend/event crawler 112 can be compared with campaign trigger definition parameters to determine whether an occurrence of a trigger event is identified. Upon identifying an occurrence of a trigger event, a corresponding trigger 120 is initiated which results in initiation, modification, or termination of the ad campaign 110. Initiation and modification of an ad campaign can include delivering an advertisement 124 according to the campaign parameters. Additionally, modification of ad campaign 110 can include changing one or more of the parameters.

In operation, for example, advertisers, once granted accounts on an advertising (“ad”) network, start by creating campaigns. To create a campaign, advertisers specify budgets, basic targeting parameters (e.g., location, gender, historical behavior, etc.), run/pause settings, and the ads themselves. Using exemplary implementations of embodiments of the inventions, advertisers can trigger or target their ads based on uncertain yet foreseeable events.

For example, in one embodiment, suppose that Carmaker is an automobile manufacturer. Carmaker understands that big purchase decisions (such as buying a car) are typically made when people feel that they have enough money to afford to make such decisions. Carmaker dealers of Bellevue and Kirkland, Wash. report a surge in sales in the months of September and October annually. This surge in sales is due to the fact that Z Corporation of Redmond Washington, a major influence in the regional economy, awards its annual cash bonus to employees on September 15th. To take advantage of the predictable injection of cash into the local economy, Carmaker can utilize an ad network as described herein, which automatically detects corporation bonus dates such as the Z Corp. bonus dates and focus advertising funds into the region.

As another example, suppose that on Monday's news headline, it is announced that Computermaker plans to cut 2500 people from its headquarters in Palo Alto, Calif. Ad campaign managers at Getajob.com wish to be able to immediately and automatically increase their ad spending for the Bay Area region in response to an event like this, as they there will be an increase in the number of high quality workers searching for new jobs. Getajob.com can utilize an ad network to automatically identify events such as layoffs. The ad network can automatically focus ad spending in the region by making adjustments to a dynamic budget.

As still another example, suppose that Utrade is an online stock broker. Looking at consumer data, Utrade realizes that its consumers are interested in the significant winners and losers of the day (e.g., those companies whose stock values experience large gains or losses). Utrade can utilize an ad network to automatically detect significant gains and losses in values of companies' stock. Consumers searching or reading stock related information can be presented with a dynamic ad such as “FooCo (FOO) drops 23% today! Time to buy FOO at Utrade.com!” It should be apparent that this type of ad can be generated using an ad template that includes fillable fields so that the name of the company, the type of change (e.g., rises or drops), the rate of change (e.g., 23%), the suggested action (e.g., buy or sell), and the advertiser's name (e.g., Foo) can be automatically modified, duplicated, and the like.

As a further example, suppose that Insurco Insurance Company realizes that the demand for insurance increases when natural disasters such as hurricanes or earthquakes makes the news headlines. This behavior is particularly observed in the region around the location of the disaster. For example, a wild fire in Los Angeles may raise fire insurance inquiries in the Bay Area. Insurco can use an ad network that automatically recognizes such events and immediately directs advertising budget to the surrounding locales. The regions, budget amounts, and the like can be customized by Insurco to optimize utilization of the foreseeable, but not certain insurance market.

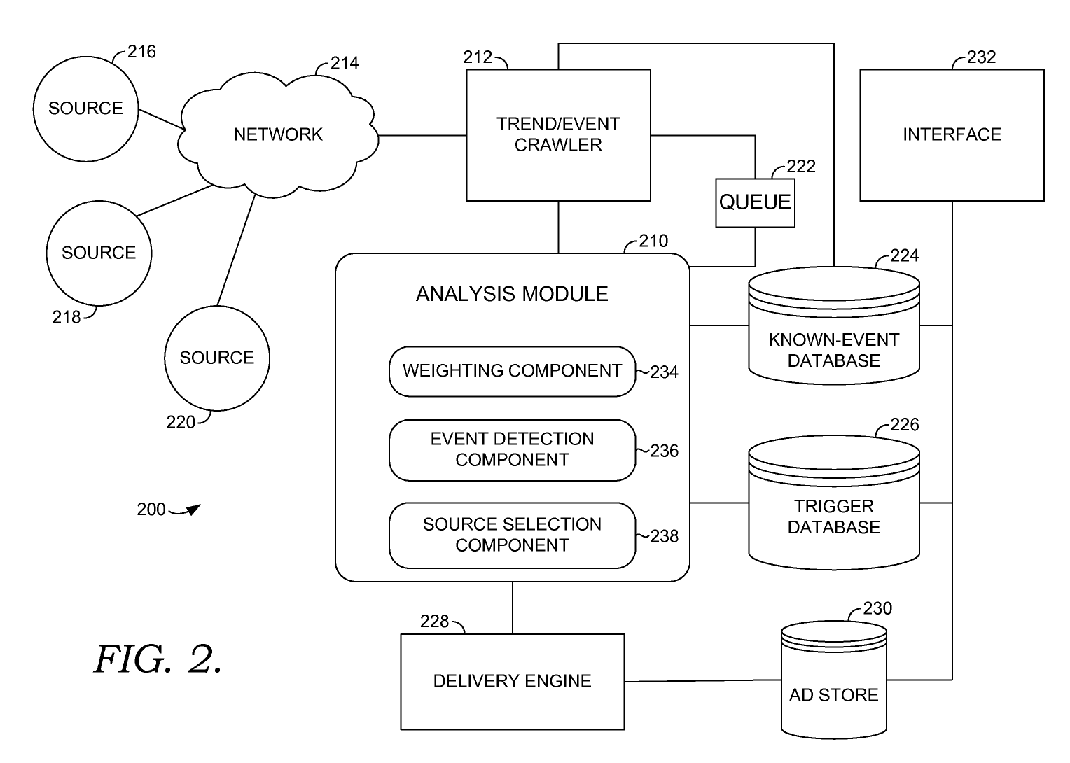

Turning now to FIG. 2, a block diagram of an exemplary system architecture 200 suitable for use in implementing embodiments of the inventions is shown. System architecture 200 includes an analysis module 210, a trend/event crawler 212, a network 214, information sources 216, 218, and 220, a queue 222, a known-event database 224, a trigger database 226, a delivery engine 228, an ad store 230, and an interface 232. Network 214 can include any kind of suitable network such as, for example, a local area network (LAN), a wide area network (WAN), the Internet, a cellular network, a peer-to-peer (P2P) network, or a combination of networks. In an embodiment of the invention, network environment 200 includes components, servers, modules, or other technology that facilitates the delivery and/or presentation of advertisements to various destinations such as, for example, mobile devices, computing devices and content providers. The exemplary system architecture 200 shown in FIG. 2 is an example of one suitable system architecture 200 and is not intended to suggest any limitation as to the scope of use or functionality of embodiments of the inventions disclosed throughout this document. Neither should the exemplary system architecture 200 be interpreted as having any dependency or requirement related to any single component or combination of components illustrated therein.

Analysis module 210, trend/event crawler 212, cue 222, known-event database 224, trigger database 226, delivery engine 228, ad store 230, and interface 232 can be implemented on any number of types of computing devices. In one embodiment, for example, analysis module 210, trend/event crawler 212, cue 222, known-event database 224, trigger database 226, delivery engine 228, ad store 230, and interface 232 can be implemented on a single computing device. In another embodiment, analysis module 210, trend/event crawler 212, cue 222, known-event database 224, trigger database 226, delivery engine 228, ad store 230, and interface 232 are each implemented on separate computing devices. In other embodiments, analysis module 210, trend/event crawler 212, cue 222, known-event database 224, trigger database 226, delivery engine 228, ad store 230, and interface 232 are implemented on a single computing device or a distributed processing system using several interconnected computing devices. In a further embodiment, combinations of the components 210, 212, 222, 224, 226, 228, 230, and 232 can be implemented on any number of machines and according to any number of various combinations.

The software components 210, 212, 222, 224, 226, 228, 230, and 232 of exemplary system architecture 200 are also scalable. That is, in embodiments of the invention, there can be varying numbers of components. For instance, in one embodiment, exemplary system architecture 200 includes one of each of analysis module 210, trend/event crawler 212, cue 222, known-event database 224, trigger database 226, delivery engine 228, ad store 230, and interface 232. In another embodiment, system architecture 200 includes only one or two of the components 210, 212, 222, 224, 226, 228, 230, and 232. Any number of configurations that provide dynamic targeting capabilities as described below can be suitable for implementing embodiments of the invention.

Analysis module 210 includes a weighting component 234, an event detection component 236, and a source selection component 238. According to embodiments of the inventions, source selection component 238 can be configured to dynamically select information sources based on any number of factors, rules, instructions, or the like. In an embodiment, source selection component 238 interfaces with a database such as known-event database 224 or trigger database 226. In one embodiment, source selection component 238 references a campaign trigger definition stored in trigger database 226.

Returning now to FIG. 2, analysis module 210 includes weighting component 234. In some embodiments, weighting component 234 can associate weights with information sources 216, 218, and 220. As trend/event crawler 212 gathers event information, that information can be interpreted by trend/event crawler 212, analysis module 210, or some other component, as event occurrence votes—indications of an occurrence of an event. Because a web crawler such as trend/event crawler 212 is a form of artificial intelligence, determining whether an event has actually occurred can typically not be a determination that can be made with absolute certainty. If occurrences of trigger events are identified when they do not actually occur, advertisers can have ads triggered at an inappropriate time, thus wasting ad budget. Similarly, if occurrences of trigger events are not identified when they actually occur, advertisers can miss opportunities, thus decreasing the efficiency of use of their ad budgets. Accordingly, analysis module 210 employs a tunable voting system to accommodate desired levels of confidence in the occurrence identifying processes.

Because not all information sources 216, 218, and 220 are equally trustworthy, weights can be assigned via weighting component 234 to event occurrence votes retrieved by trend/event crawler 212. In embodiments, weighting component 234 creates a weighted vote by associating a weighting factor corresponding to an information source with an event occurrence vote retrieved from that information source. In embodiments, weighting factors can be provided by advertisers. In other embodiments, weighting factors can be included within campaign trigger definitions. In still further embodiments, weighting factors can be predetermined or dynamically calculated using any number of types of algorithms suitable for assigning weighting factors to information sources based on trustworthiness. In various embodiments, weighting component 234 can test assigned weighting factors for accuracy, and can dynamically update weighting factors as more information is learned by the system, thus optimizing the triggering of ad campaigns.

In some embodiments, any number of advertiser configuration options can be provided so that the advertiser can customize the weighted voting system employed by embodiments of the invention. In an embodiment, for example, a trigger definition can include a specification of a minimum vote reserve, which indicates that a certain total vote (which is an aggregation of weighted votes) must meet a particular threshold before an ad campaign is triggered. Generally, it should be understood that more authoritative sources such as news agencies can be associated with higher weighting factors than less authoritative sources such as blogs and other consumer-generated content.

As further illustrated in FIG. 2, analysis module includes event detection component 236. Event detection component 236 analyzes weighted votes retrieved from weighting component 234 to determine whether the weighted votes, individually or together, identify an occurrence of a trigger event. In some embodiments, for example, a vote can be assigned a value such as a one or a zero, although in other embodiments, any number of different values can be assigned based on the ad campaign structure. Weighting factors can include fractions, percentages, real numbers, rational numbers, integers, and the like. Thus, it should be understood that, in some embodiments, a weighted vote can comprise the product of a vote multiplied by its corresponding weighting factor. In embodiments, event detection component 236 can sum all of the weighted votes retrieved with reference to a particular trigger event and determine whether the resulting sum meets or exceeds a minimum voting reserve. In other embodiments, other methods and algorithms can be used to weight votes and aggregate weighted votes for determining whether a trigger event occurrence is identified.

Analysis module also includes source selection component 238, as shown in FIG. 2. Source selection component 238 can be configured to identify one or more information sources from which to retrieve event occurrence data associated with a campaign trigger definition. In some embodiments, information sources can be specified within a trigger definition, in which case, source selection component 238 can reference the trigger definition to identify the information sources. In other embodiments, hints or guidelines for selecting information sources can be included within a trigger definition, which is referenced by source selection component 238. In further embodiments, some information sources can be predetermined and correspond to a trigger class, trigger ID, or the like. That is, source selection component 238 can be configured to identify, for example, a particular news company as an information source for any trigger definition that includes a “Breaking News” trigger class. In still further embodiments, source selection component 238 can dynamically select information sources based on data provided within a trigger definition, from a database, or via interface 232. Such dynamic selection of information sources can be refined over time as analysis module 210 assesses the trustworthiness (e.g., apparent accuracy and reliability) of information sources.

According to an embodiment of the invention, trend/event crawler 212 gathers time-stamped information from information sources 216, 218, and 220. In embodiments, trend/event crawler 212 references, receives instructions from, or otherwise communicates with source selection component 238 to identify information sources 216, 218, and 220 from which event information is to be retrieved, what type of information is to be retrieved, how often information is to be retrieved, and the like.

In embodiments, information sources 216, 218, and 220 can include, for example, authoritative sources such as news reporters, market reporters, and the like. In some embodiments, trend/event crawler 212 visits the home page of authoritative sources and uses article titles as definitive event occurrence votes. Information sources 216, 218, and 220 can also include, for example, search engines. In embodiments, trend/event crawler 212 visits the uniform resource locator (URL) for the search service. In some embodiments, source selection component 238, analysis module 210, or trend/event crawler 212 can be configured to construct a URL corresponding to the search service, where the URL has the search term already filled in. For example, a trigger definition could include a URL for identifying an occurrence of a wildfire: http://search.live.com/news/results.aspx?q=wildfire.

In other embodiments of the invention, information sources 216, 218, and 220 can include stock quotes and weather information sources. In embodiments, trend/event crawler 212 visits the corresponding URL, which might include the particular stock symbol or zip code. According to some embodiments, trend/event crawler 212 only needs to extract elements such as price, gain/loss percentage or temperature, humidity, and the like. In still further embodiments, information sources 216, 218, and 220 can include user-generated content such as, for example, blogs, product reviews, bulletin boards, and the like. In various embodiments of the invention, trend/event crawler 212 can utilize RSS feeds, which include “real-time” updates.

According to some embodiments of the invention, trend/event crawler 212 can crawl any sites that the advertiser defines such as, for example, by including the definitions as parameters in a campaign trigger definition. In embodiments, the advertiser can specify what the crawler needs to look for—keywords, HTML/XML tags, and the like. Additionally, any combination of the above or other types of information sources can be referenced within the context of various embodiments of the invention.

With continued reference to FIG. 2, trend/event crawler 212 can be configured to read, extract, or retrieve any number of different types of data. In an embodiment, when trend/event crawler 212 visits a webpage, it can read in the HTML that comprises the web page. The visible text and content of the webpage generally are embedded within the HTML tags. Typically, trend/event crawler 212 retrieves information corresponding to the actual content of the page rather than the HTML around it, however, in embodiments, trend/event crawler 212 can be configured to retrieve the HTML as well.

According to embodiments of the invention, trend/event crawler 212 can be configured to look for different types of content and can be configured to engage in varying levels of searching. For example, in an embodiment, trend/event crawler 212 searches information sources 216, 218, and 220 for keywords. Embodiments of a simple keyword search can include a simple phrase match. That is, if the keyword is present in the content, then an occurrence of the event is identified. A more sophisticated keyword search might include discovering the elements of the content such as, for example, a location of the event. If trend/event crawler 212 encounters a phrase such as “wildfire near Santa Barbara”, while looking for “wildfire”, the crawler can reference the trigger definition to determine whether this location is included in the parameters, and if so, trend/event crawler 212 can automatically extract the location information from the source.

In even more sophisticated crawls, trend/event crawler 212 can determine trends or sentiment associated with certain facts, products, data, behaviors, and the like. To identify trends or sentiment, a cluster of keywords can be used with weighting factors assigned thereto. For example, if trend/event crawler 212 searches for a positive sentiment associated with some event, it could look for keywords such as “happy,” “excited,” “love,” “bright,” “good,” “positive,” and the like. Each keyword would contribute to the overall decision based on a corresponding weighting factor. For example, with reference to the positive sentiment search, “happy” might be associated with much larger weighting factors than “decent” or “good.” In some embodiments, trend/event crawler 212 searches for negative keywords as well when attempting to detect positive sentiment because negative keywords could have opposing weight and may tend to influence an overall identification of an occurrence of a trigger event.

As FIG. 2 further illustrates, trend/event crawler 212 interfaces with a queue 222 that can be used for temporary storage and/or staging of time-stamped information. In an embodiment, queue 222 can include a table, a relational database, or any other database structuring scheme that allows for a searchable warehouse of time-stamped data. In embodiments, analysis module 210 references queue 222 to access information retrieved by trend/event crawler 212. In other embodiments, queue 222 can be integrated with analysis module 210, trend/event crawler 212, or some other component illustrated or not illustrated in FIG. 2.

Known-event database 224 includes information associated with predetermined trigger events, where occurrence of the trigger events are nearly certain. Trigger database 226 can include, for example, a database for storing trigger definitions, a cache for temporarily storing trigger definitions, and the like. Additionally, in some embodiments, trigger database 226 is integrated with known-event database 224. In other embodiments, trigger definitions include information associated with predetermined trigger events, and therefore a separate known-event database 226 is redundant. In further embodiments, any number of databases 224, 226 can be integrated with analysis module 210.

Databases 224, 226 provide information for managing advertising campaigns for presentation of advertisements to consumers. In an embodiment, each of databases 224, 226 is a content server that has associated storage for storing information such as trigger definitions, URLs, consumer profiles, configuration data, and the like. In an embodiment, either one or the other or both databases 224, 226 can be a server, computing device, or software module that can maintain information. In embodiments, databases 224, 226 might be computing devices associated with a company that produces advertisements. In another embodiment, databases 224, 226 can be integrated with servers that can maintain, and manage numbers of advertisements that are associated with and received from various originating entities. It should be appreciated that databases 224, 226 can be designed to operate within various business models, ad inventory bidding schemes, and the like.

In an embodiment, database 224, 226 is a database or other data storage module. In one embodiment, database 224, 226 can be associated with delivery engine 228, interface 232, or another component of exemplary system architecture 200 not illustrated in FIG. 2. Databases 224, 226 can be maintained on a single device, or can be distributed across several devices such as, for instance, in an implementation in which one or more of databases 224, 226 is a database cluster. Databases 224, 226 can be structured according to a variety of techniques and can be configured to be searchable. For example, in one embodiment, database 224, 226 includes a table. In another embodiment, database 224, 226 is a relational database that includes advertiser identifiers that identify advertisers stored in database 226 as well as data associated with various attributes corresponding to the advertiser identifiers such as, for example, data associated with campaign trigger definitions.

With continued reference to FIG. 2, network environment 200 includes delivery engine 228. In some embodiments, delivery engine 228 can be implemented on the same machine as analysis module 210 and/or trend/event crawler 212. In other embodiments, delivery engine 228 can be implemented independently of other components of network environment 200. Delivery engine 228 can be any type of server, software module, computing device or the like that is capable of communicating with other devices. Delivery engine 228 provides advertisements or links to advertisements to other devices such as consumer devices, content providers, and the like. In some embodiments, advertisements include hyperlinks or other types of references that allow a consumer to access web sites, information, databases, and the like. Delivery engine 228 can facilitate consumer interaction with those advertisements by resolving references, mapping hyperlinks to addresses, retrieving websites, searching content, and rendering content. In some embodiments, delivery engine 228 can also provide click-through services for reporting consumer interaction with content.

Delivery engine 228 can interface with an ad store 230. Ad store 230 can include, for example, an ad database, a cache for temporarily storing advertisements and other content before providing the advertisements and/or other content to consumers, and the like. Additionally, in some embodiments, delivery engine 228 is integrated with ad store 230. In other embodiments, delivery engine 228 is integrated with analysis module 210. In an embodiment, delivery engine 228 generates a searchable index of the advertisements and related data stored in ad store 230.

Ad store 230 provides advertisements for presentation to consumers. In an embodiment, ad store 230 is a content server that has associated storage for storing advertisements, and can also include links to advertisements, information about advertisements, metadata, device location data, advertiser profile information, and the like. In an embodiment, ad store 230 can be a server, computing device, or software module that can provide advertisements or links to advertisements. In embodiments, ad store 230 might be a computing device associated with a company that produces advertisements. In another embodiment, ad store 230 can be a server that can collect, maintain, and manage numbers of advertisements that are associated with and received from various originating entities. It should be appreciated that ad store 230 can be designed to operate within various business models, purchasing schemes, and the like.

In an embodiment, ad store 230 is a database or other data storage module. In one embodiment, ad store 230 can support an advertising (ad) database. In other embodiments, ad store 230 can be associated with delivery engine 228, interface 232, or another component of network environment 200 not illustrated in FIG. 2. Ad store 230 can be maintained on a single device, or can be distributed across several devices such as, for instance, in an implementation in which ad store 230 is a database cluster. Ad store 230 can be structured according to a variety of techniques and is configured to be searchable. For example, in one embodiment, ad store 230 includes a table. In another embodiment, ad store 230 is a relational database that includes advertisement identifiers that identify advertisements stored in ad store 230 as well as data associated with various attributes corresponding to the advertisement identifiers. Advertisement identifiers can include dynamically generated identification codes, hyperlinks, URLs, or other addressing or identifying information. In one embodiment, an attribute or attributes can represent information that indicates a geographical region wherein the advertisement corresponding to the associated advertisement identifier should be presented.

For instance, in an embodiment, an advertisement provider such as ad store 230 can specify particular geographical regions in which an ad should be presented to a consumer. That way, for example, a local sandwich shop can specify that an advertisement related thereto is presented to consumers when the consumers are within a certain distance from the shop. In another embodiment, the shop might specify that the advertisement should be played to consumers in the same town, to consumers on the same city block, and the like. According to another embodiment, ad store 230 can include scripts, APIs, or other software modules that facilitate presentation of advertisements to consumers.

Ad store 230 also may be configured to store information associated with various types of advertisements. In various embodiments, such information may include, without limitation, one or more unapparent advertisements, one or more image advertisements, one or more consumer feedback advertisements, advertiser and/or publisher identities and the like. In some embodiments, ad store 230 is configured to be searchable for one or more advertisements to be selected for presentation.

Information stored in ad store 230 may be configurable and may include any information relevant to an advertisement. Further, though illustrated as a single, independent component, ad store 230 may, in fact, be a plurality of databases, for instance, a database cluster, portions of which may reside on a computing device associated with the ad store 230 or the delivery engine 228, another external computing device (not shown), and/or any combination thereof.

In embodiments, interface 232 can include an interface, an application programming interface (API), a method, a function call, a hardware device, or any other type of conduit configured for allowing information to be provided to various components illustrated in FIG. 2. In one embodiment, interface 232 provides a user interface that allows an advertiser to configure a campaign trigger definition associated with an advertising campaign. Interface 232 allows the advertiser to provide the campaign trigger definition to trigger database 226. In other embodiments, interface 232 can facilitate a advertiser providing information about predicted events to well-known event database 224, advertising content to ad store 230, and the like. In various embodiments, interface 232 can be configured to allow other types of configuration activities, management of advertiser accounts, selection of advertising options, and the like.

Information stored in ad store 230 may be configurable and may include any information relevant to an advertising campaign or advertiser. Further, though illustrated as a single, independent component, each of databases 224 and 226 may, in fact, be a plurality of databases, for instance, a database cluster, portions of which may reside on a computing device associated with the databases 224, 226 or the delivery engine 228, another external computing device (not shown), and/or any combination thereof.

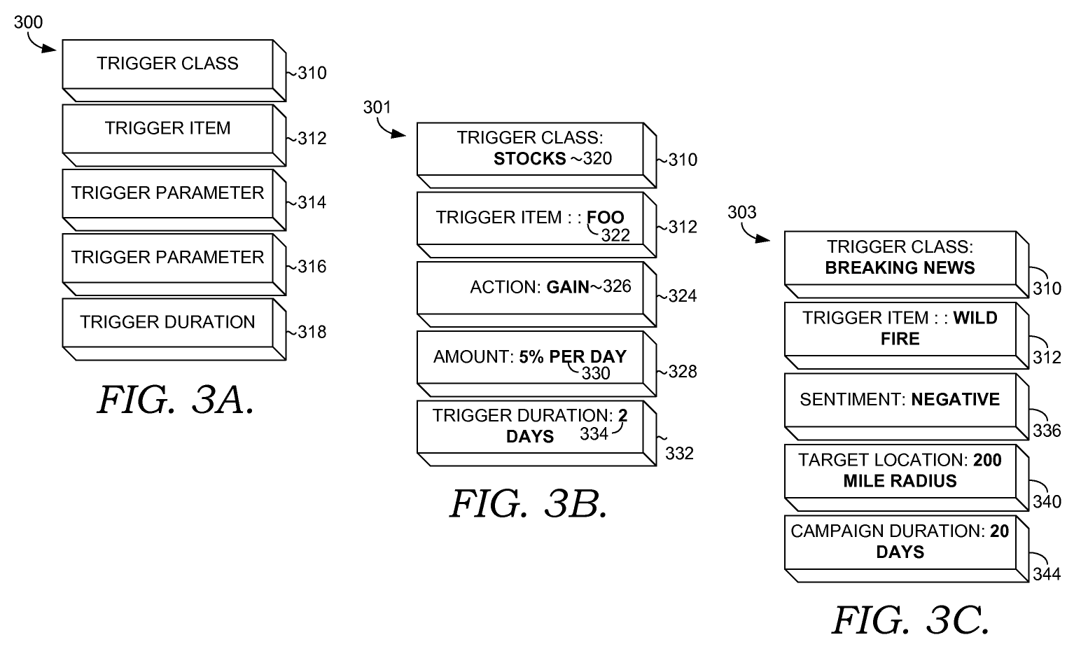

Turning briefly to FIGS. 3A-3C, an exemplary campaign trigger definition is illustrated. FIG. 3A depicts an illustrative campaign trigger definition 300. Campaign trigger definition 300 includes a number of trigger elements 310, 312, 314, 316, and 318. Although any number of additional elements could be defined, some embodiments of a trigger definition 300 include a first trigger element 310 that specifies a parameter for the trigger definition: “trigger class.” The trigger class or classification identifies the type of campaign trigger. For example, a trigger class could include event types such as stocks, breaking news, sports scores, and the like.

Additionally, the exemplary trigger definition 300 includes a second trigger element 312 that specifies another parameter: “trigger item.” The trigger item 312 can be used to specify, for example, a subset of the corresponding trigger class. In an embodiment, trigger item 312 identifies a party, an entity, a name, a holiday, or the like. For example, as illustrated in FIG. 3B, in one embodiment, the trigger class 310 might be specified as stocks 320. The corresponding trigger item 312 identifies FOO, which could represent a publicly traded company. Accordingly, these two trigger definition elements 310 and 312 indicate that the exemplary trigger definition 301 identifies a trigger event as being one that corresponds to the current value of shares of FOO stock.

As further illustrated in FIG. 3B, a third trigger element 324 includes a parameter specifying an action corresponding to the trigger class 310 and trigger item 312: “gain.” Thus, the first three illustrated trigger elements in FIG. 3B establish that the corresponding trigger event can be characterized as a gain in the value of FOO stock. That is, according to various embodiments of the invention, when the value of FOO stock rises, an associated ad campaign is initiated or modified. The exemplary trigger definition 301 illustrated in FIG. 3B further includes a trigger element 328 that includes a parameter specifying a minimum threshold rate 330 of gain and an element 332 specifying a duration for which the threshold rate must be exceeded to identify an occurrence of the trigger event. Thus, if FOO stock increases in value by at least 5% per day, an occurrence of the trigger event is identified, and an action is performed on the corresponding ad campaign.

In embodiments, the ad campaign is initiated incident to identification of the occurrence of the trigger event. With reference to FIG. 3B, if a crawler retrieves information indicating that the value of FOO stock has gained more than 5% for each of the last two days, an ad may be automatically delivered to visitors to a website that offers current stock quotes. In one embodiment, a simple advertisement could even be created using the trigger elements 310, 312, 324, 328, and 332, and may, for example, display the following text to a consumer: “FOO stock is up 10% per day for 2 days in a row! Now is the time to sell FOO stock! Click here to allow Contessa Stock Traders, Inc. to help you sell FOO stock.”

To further illustrate the functionality of embodiments of the invention, FIG. 3C further illustrates another exemplary trigger definition 303. The first element 310 specifies the trigger class as “breaking news,” and the trigger item 312 as “wild fire.” The trigger definition 303 depicted in FIG. 3C includes a third trigger element 336 that specifies a sentiment parameter 338: “negative.” Therefore, if breaking news about a wildfire is encountered by the crawler as it peruses news sources, and the sentiment of the breaking news is generally negative (e.g., the news story discusses the negative impact on residents that the wild fire has), the corresponding ad campaign may be triggered. Triggering an ad campaign can include performing an operation corresponding to the ad campaign such as, for example, initiating the ad campaign, delivering one or more ads according to parameters associated with the ad campaign, modifying the campaign trigger definition; terminating the ad campaign, and the like.

As further illustrated in FIG. 3C, a campaign trigger definition 303 can include parameters related to identifying an occurrence of a trigger event as well as parameters related to the delivery of advertisements, management of the ad campaign, and the like. For example, the illustrative trigger definition 303 includes a trigger element 340 that specifies a target location parameter. In FIG. 3C, incident to occurrence of a negative breaking news story about a wild fire, an ad for house insurance could be delivered or made available to consumers within a 200 mile radius of the wild fire. Additionally, as illustrated, a trigger element 344 can be included that specifies a duration associated with the running of an ad campaign. The ad campaign associated with the exemplary trigger definition 303 is configured to run for 20 days after identification of an occurrence of the trigger event.

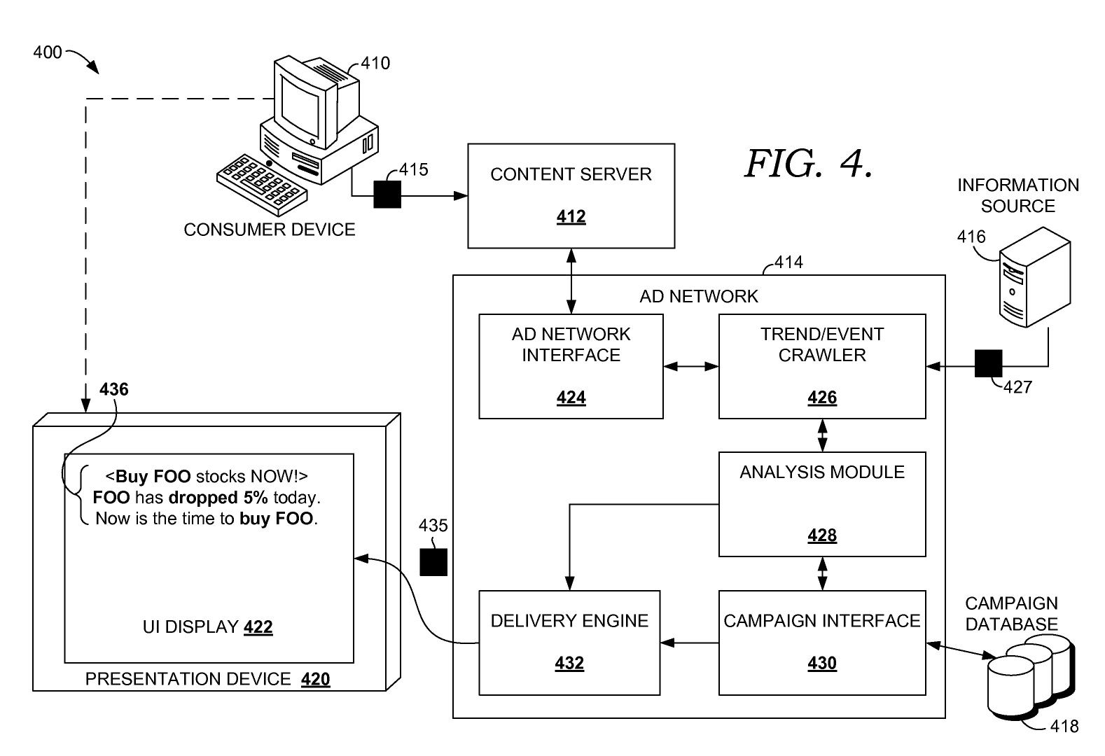

Turning now to FIG. 4, an exemplary system architecture 400 is depicted in accordance with embodiments of the invention. Exemplary system architecture 400 includes a consumer device 410, a content server 412, an ad network 414, an information source 416, and a campaign database 418. As further illustrated in FIG. 4, consumer device includes a presentation device 420 and ad network 414 includes an ad network interface 424, a trend/event crawler 426, an analysis module 428, a campaign interface 430, and a delivery engine 432. This exemplary system architecture 400 is but one example of a suitable environment that may be implemented to carry out aspects of embodiments of the invention and is not intended to suggest any limitation as to the scope of use or functionality of the invention. Neither should the illustrated exemplary system architecture 400, or the ad network 414, be interpreted as having any dependency or requirement relating to any one or combination of the components 412, 416, 418, 424, 426, 428, 430, and 432 as illustrated. In some embodiments, one or more of the components 412, 416, 418, 424, 426, 428, 430, and 432 may be implemented as stand-alone devices. In other embodiments, one or more of the components 412, 416, 418, 424, 426, 428, 430, and 432 may be integrated directly into the consumer device 410. Components 412, 416, 418, 424, 426, 428, 430, and 432 illustrated in FIG. 4 are exemplary in nature and in number and should not be construed as limiting.

Accordingly, any number of components may be employed to achieve various types of functionality within the scope of embodiments of the inventions described herein. Although the various components of FIG. 4 are shown with lines for the sake of clarity, in reality, delineating various components is not so clear, and metaphorically, the lines would more accurately be grey or fuzzy. Further, although some components of FIG. 4 are depicted as single blocks, the depictions are exemplary in nature and in number and are not to be construed as limiting (e.g., although only one presentation device 420 is shown, many more may be communicatively coupled to the consumer device 410).

Exemplary system architecture 400 includes the consumer device 410 for, in part, supporting operation of the presentation device 420. In an exemplary embodiment, where the consumer device 410 is a mobile device for instance, the presentation device (e.g., a touchscreen display) may be disposed on the consumer device 410. In addition, the consumer device 410 can take the form of various types of computing devices. By way of example only, the consumer device 410 may be a personal computing device (e.g., computing device 100 of FIG. 1), handheld device (e.g., personal digital assistant), a mobile device (e.g., laptop computer, cell phone, media player), consumer electronic device, various servers, and the like. Additionally, the computing device may comprise two or more electronic devices configured to share information with each other.

In one embodiment, for example, consumer device 410 is a personal computer (PC) that a consumer has at home or at work. In a further embodiment, consumer device 410 can be a kiosk, a public network access terminal, a media management system such as may be available on a TV in a hotel room, or other device. According to embodiments of the invention, consumer device 410 can communicate with one or more of the other elements illustrated in FIG. 4. For example, in an embodiment consumer device 410 can communicate with ad network 414 and/or content server 412, either directly or indirectly through a network. In another embodiment, consumer device 410 can communicate with ad network 414, content server 412, or other network nodes not illustrated.

In embodiments, as discussed above, the consumer device 410 includes, or is operably coupled to the presentation device 420, which is configured to present a user-interface (UI) display 422 on the presentation device 420. The presentation device 420 can be configured as any display device that is capable of presenting information to a consumer, such as a monitor, electronic display panel, touch-screen, liquid crystal display (LCD), plasma screen, or any other suitable display type, or may comprise a reflective surface upon which the visual information is projected. Although several differing configurations of the presentation device 420 have been described above, it should be understood and appreciated by those of ordinary skill in the art that various types of presentation devices that present information may be employed as the presentation device 420, and that embodiments of the invention are not limited to those presentation devices 420 that are shown and described.

In one exemplary embodiment, the UI display 422 rendered by the presentation device 420 is configured to surface a web page (not shown) that is associated with ad network 414 and/or a content publisher. In embodiments, the web page may reveal a search-entry area that receives a query and presents search results that are discovered by searching the Internet, an intranet, a website, a database, or the like, with the query.

As FIG. 4 further illustrates, exemplary system implementation 400 includes a content server 412. Content server 412 can include a server or other computing device that can communicate content to other devices such as, for example, consumer device 410. In other embodiments, content server 412 includes a network. Content can include, for example, documents, files, search results, applications, music, videos, scripts, streaming multimedia and the like. In an embodiment, content server 412 can provide content to a consumer device 410 by way of a network, a number of networks, or directly. In some embodiments, content provider 412 can be part of ad network 414. In other embodiments, content provider 412 is independent of other elements illustrated in FIG. 4 and described above.

With further reference to FIG. 4, the exemplary system implementation 400 includes an ad network 414. Ad network 414 includes an ad network interface 424, a trend/event crawler 426, an analysis module 428, a campaign interface 430, and a delivery engine 432. In various embodiments, any one or more of ad network interface 424, trend/event crawler 426, analysis module 428, campaign interface 430, and delivery engine 432 can be implemented on a single computing device. In other embodiments, each component 424, 426, 428, 430, and 432 can be implemented independently of the others. In one embodiment, for example, ad network interface 424, trend/event crawler 426, analysis module 428, campaign interface 430, and delivery engine 432 can be maintained on a server, not illustrated in FIG. 4. Any combination of components 424, 426, 428, 430, and 432 can be implemented, in some embodiments, on any combination servers. These are only a few illustrative embodiments, and a number of other implementation schemes that can be used to provide functionality of embodiments of the invention as described herein are within the ambit of embodiments of the invention.

Ad network interface 424 can include any type of server, software module, or the like that is configured to allow communication between content server 412 and ad network 414. In embodiments, ad network interface 424 allows content server 412 to provide information to ad network 414 about a request 415 for content received from a consumer device 410. In this manner, ad network 414 can apply various algorithms and the like so that advertisements are targeted based, at least in part, on the request 415. Any number of other types of information can be passed using ad network interface 424. For example, in another embodiment, ad network interface 424 facilitates delivery of advertising content via delivery engine 432 to content server 412 so that content server 412 can ultimately cause an advertisement 436 to be rendered via a user interface (UI) display 422 on a presentation device 420 associated with consumer device 410.

As illustrated in FIG. 4, ad network 414 includes trend/event crawler 426, which retrieves event information 427 from information source 416. According to embodiments, the functions of the trend/event crawler 426 can remain substantially similar between embodiments of the ad system as illustrated in FIG. 2 and the ad network as illustrated in FIG. 4. Additionally, ad network 414 includes an analysis module 428 and a campaign interface 430. Similarly, according to embodiments, the functions of analysis module 428 and campaign interface 430 can remain substantially similar between embodiments of the ad system as illustrated in FIG. 2 and the ad network as illustrated in FIG. 4.

Campaign database 418 can be used to store advertisements and information associated with advertisements. Campaign database 418 can include one or more advertisement databases. Campaign database 418 can include indexes associated with advertisement databases, and can also include information associated with advertisements, mappings between hyperlinks and content, and other types of content. In some embodiments, campaign database 418 can be used to store scripts, APIs, and the like. In one embodiment, campaign database 418 includes ad content associated with ad campaigns. Ad content can include text, graphics, animation, video, audio, and the like.

Additionally, in some embodiments, ad content includes ad templates that represent “fillable” ad content. An ad template can include parameters to be used to render an ad impression (e.g., to display an advertisement). Ad templates can also include placeholders for dynamic content. The dynamic content can be filled periodically, according to one or more rules or conditions, or even just before ad delivery. In the latter case, the dynamic content can include crawler elements, which are pieces of information gathered by trend/event crawler 426. In this manner, an advertiser can construct an ad template such that, for example, parts of a displayable ad are predetermined, but blanks are configured to be filled in with the results obtained from trend/event crawler's 426 perusal of information sources in accordance with a corresponding campaign trigger definition. Therefore, when a trigger event occurs, information about the trigger event can be immediately inserted into the ad template to create a nearly-instantaneous ad content that is contextually relevant to an event that was foreseeable, but not precisely predictable.

As an example, an ad template in campaign database 418 might look like the following, where placeholders for dynamic content are represented as spaces for crawler elements (CEs), {CE1}, {CE2}, and {CE3}:

<Buy {CE1} Merchandise!>
Celebrate with {CE1} in their victory against the {CE2} on {CE3}.

A corresponding campaign trigger definition would include several trigger elements as follows:

Trigger Class: Sports

Trigger Item: Basketball

Trigger Parameter: Win

Moreover, the advertiser can configure the ad campaign to have the crawler elements be assignable variables so that the trend/event crawler 426 knows what information is required and so that the information can be immediately inserted into the ad template as soon as it is obtained by trend/event crawler 426. Accordingly, in the present example, the advertiser could make the following assignments: CE1: winning team; CE2: losing team; and CE3: event date. Thus, if the Tigers are playing the Lions in an important tournament playoff game, the ad campaign can be configured to deliver ad content to consumers as soon as the final score is reported. Thus, if the Tigers win the game, trend/event crawler 426 identifies the occurrence of the event and also collects the crawler elements CE1, CE2, and CE3, and analysis module 428 inserts the crawler elements into the place holders in the ad template. The ad content 435 is delivered and rendered as an ad impression 436 to one or more consumers:

<Buy Tigers Merchandise!>
Celebrate with Tigers in their victory against the Lions on
March 13^{th}, 2009.

With continued reference to FIG. 4, delivery engine 432 facilitates the presentation of advertisements (i.e., ad content) 435 to consumer device 410. In an embodiment, delivery engine 432 provides advertisements 435 to consumer device 410. Advertisements 435 can include, for example, actual advertising content, information about advertising content, hyperlinks to advertisements, references to advertisements, coupons, and the like. Additionally, according to embodiments of the invention, advertisements 435 can include scripts, software modules, and APIs that can be invoked to render advertising impressions 436 on a presentation device 420. Advertisements 435 can be of any number of different formats such as audio, video, textual, graphical, and the like. In some embodiments, advertisements 435 can be interactive and in other embodiments, advertisements 435 are accompanied by click-through functionality so that consumer interaction with the advertisements 435 can be monitored and logged. In some embodiments, delivery engine 432 resolves references, maps connections through hyperlinks, retrieves advertising content, streams content to consumer device 410, monitors click-throughs, and the like. In other embodiments, any one or more of those functions can be performed by other components of the system implementation 400.

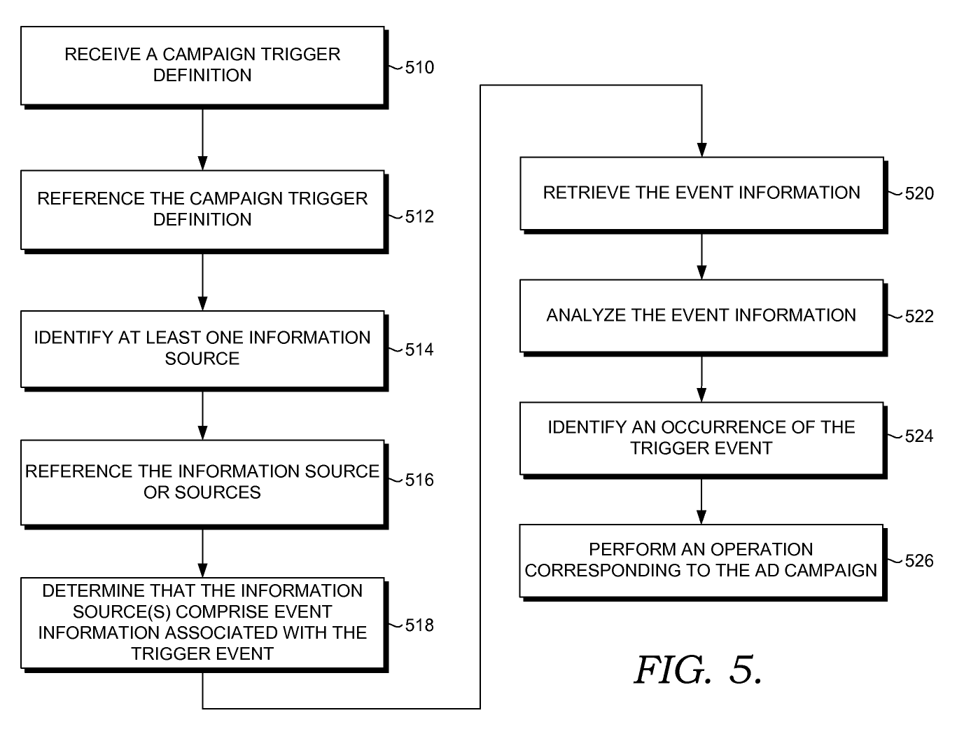

Turning now to FIG. 5, a flow diagram is illustrated that shows an exemplary method for managing an advertising campaign in accordance with embodiments of the invention. Initially, as depicted at block 510, embodiments of the exemplary computer-implemented method include receiving a campaign trigger definition corresponding to an advertising campaign. The campaign trigger definition can include an identification of a trigger event as well as an identification of an operation to be performed incident to identifying the occurrence of the trigger event. In embodiments, the campaign trigger definition can include advertiser-specified events, advertiser-specified information sources, and other customized parameters. The operation to be performed corresponds to the advertising campaign and can include, for example, initiating the advertising campaign, modifying the advertising campaign, modifying the campaign trigger definition, terminating the advertising campaign, and the like. In embodiments, the campaign trigger definition is provided to an ad network by way of an interface and is stored in a trigger database. Advertisers and others (e.g., advertisers, advertising agents, publishers, etc.) can provide campaign trigger definitions through the interface in some embodiments. In other embodiments, the interface can be configured to retrieve campaign trigger definitions from a computing device, network, system, or other machine associated with an advertiser.

As depicted at step 512, an analysis module references the campaign trigger definition. Referencing the campaign trigger definition can include retrieving the definition, searching the definition for particular information, extracting information from the campaign trigger definition, and the like. The analysis module references the campaign trigger definition to obtain values for parameters used in managing the advertising campaign. At step 514, the analysis module identifies at least one information source and, at step 516, the analysis module causes a crawler to reference the at least one information source. In an embodiment, the information source includes a network site such as, for example, a web site. In other embodiments, the information source includes a database. The analysis module can identify an information source by referencing the campaign trigger definition, referencing a database, or querying a database using information provided in the campaign trigger definition.

Further, as depicted at step 518, the analysis module and/or crawler determines that at least one information source includes event information associated with the trigger event. Event information can include any kind of information, data, values, or other content that can be used by the analysis module in determining whether a trigger event has occurred. For example, in an embodiment, event information can include an event occurrence vote retrieved from the information source. Event occurrence votes are indications about the occurrence of a trigger event. Because the authoritativeness associated with various information sources can vary dramatically, an aggregation of weighted votes from different information sources can be used in determining whether occurrence of a trigger event is identified. Weighting factors corresponding to each information source are referenced and associated with event occurrence votes retrieved from the information sources to create weighted votes. The weighted votes can be analyzed to determine whether the weighted votes identify an occurrence of the trigger event.

With continued reference to FIG. 5, the analysis module retrieves and analyzes event information, as shown at steps 520 and 522, respectively. Then the analysis module identifies an occurrence of the trigger event, as depicted at step 524. As illustrated in a final illustrative step 526, incident to identifying occurrence of the trigger event, the analysis module causes an operation to be performed on the advertising campaign. For example, in an embodiment, performing the operation can include initiating the advertising campaign or modifying a trigger element (e.g., identification of the trigger event, threshold levels, other parameters, etc.) associated with the advertising campaign. Additionally, in embodiments, performing the operation can include referencing the campaign trigger definition to determine a duration associated with the advertising campaign. In other embodiments, performing the operation can include modifying ad to make the content more contextually relevant in light of the trigger event. In further embodiments, performing the operation can include selecting one or more advertisements based on the trigger event.

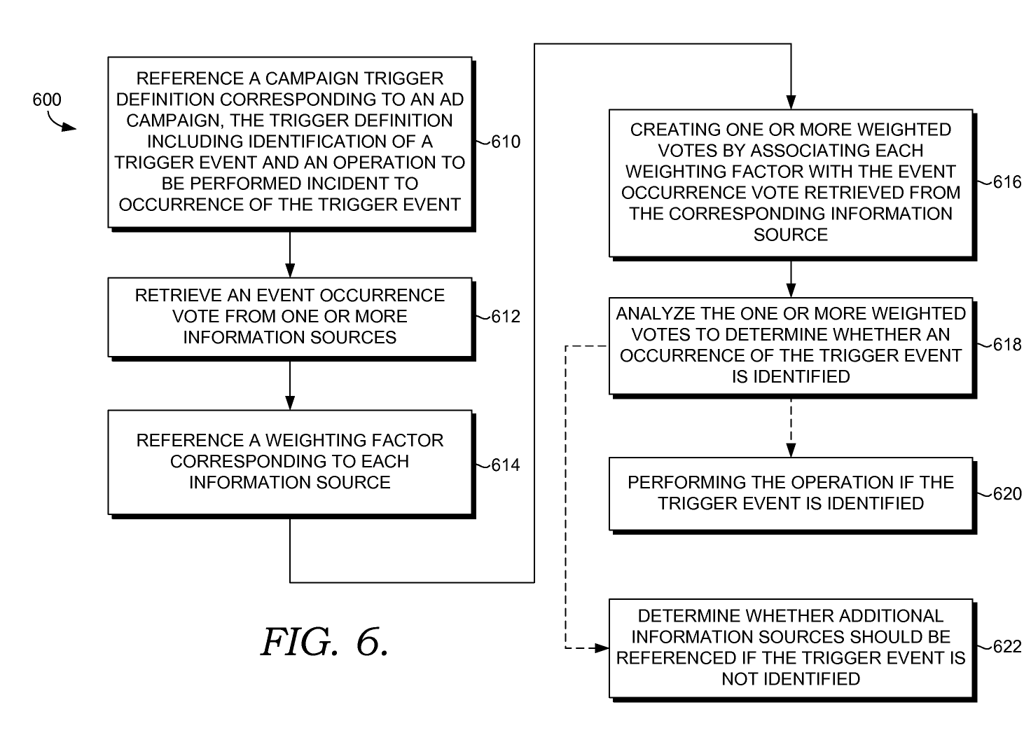

Turning to FIG. 6, an exemplary computer-implemented method of managing an advertising campaign in which trigger event occurrences are determined according to an assessment of weighted votes is illustrated using a flow diagram. At an illustrative first step 610, an analysis module references a campaign trigger definition corresponding to an advertising campaign. The campaign trigger definition includes an identification of a trigger event and an identification of an operation associated with the advertising campaign to be performed incident to identifying an occurrence of the trigger event. As further illustrated at step 612, a crawler retrieves an event occurrence vote from each of one or more information sources.

As shown at step 614, the analyzer references a weighting factor corresponding to each information source. In an embodiment, the weighting factor corresponding to each information source is established based on a source classification associated with each information source. In embodiments, source classifications include indications relating to the authoritativeness associated with each information source. For example, a first source classification could indicate that a first information source is an authoritative source such as, for example, a news agency web site. In embodiments, a second course classification might indicate that a second information source is advertiser-defined.

With continued reference to FIG. 6, at step 616, the analysis module creates one or more weighted votes by associating each weighting factor with the event occurrence vote retrieved from the information source corresponding to the weighting factor. At step 618, the analysis module analyzes the weighted votes to determine whether the weighted votes identify an occurrence of the trigger event. In embodiments, analyzing a weighted vote retrieved from an authoritative source can include determining that the weighted vote identifies an occurrence of the trigger event. In another embodiment, analyzing a weighted vote corresponding to a user-generated information source can include determining that the weighted vote does not identify an occurrence of the trigger event. That is, even though the source may literally indicate an occurrence of the trigger event, if the information source is not authoritative, the system may not treat that indication as an actual identification of an occurrence of the trigger event. Thus, as depicted at step 622, the analysis module determines whether additional information sources should be referenced. The system may, in some embodiments, continue to obtain additional weighted votes and may consider an occurrence of the trigger event to be identified where the aggregated weighted votes exceed some predetermined threshold. Incident to determining that an occurrence of the trigger event has been identified, the analysis module causes the operation to be performed, as shown at step 620.

Various embodiments of the invention have been described to be illustrative rather than restrictive. Alternative embodiments will become apparent from time to time without departing from the scope of embodiments of the inventions. For example, in an embodiment, systems and methods described herein can support access by devices via application programming interfaces (APIs). In other embodiments, trend/event crawlers can be configured to crawl information sources to retrieve information for a number of trigger definitions. In some embodiments, trend/event crawlers can run continuously and in other embodiments, trend/event crawlers can retrieve information in response to receiving instructions to do so.

It will be understood that certain features and sub-combinations are of utility and may be employed without reference to other features and sub-combinations. This is contemplated by and is within the scope of the claims.

The invention claimed is:

1. One or more computer-readable media having computer-executable instructions embodied thereon for performing a method of managing an advertising campaign, the method comprising:
receiving a campaign trigger definition corresponding to an advertising campaign, the campaign trigger definition comprising an identification of a trigger event and identification of an operation to be performed incident to identifying the occurrence of the trigger event, wherein the operation to be performed corresponds to the advertising campaign;
referencing the campaign trigger definition;
identifying at least one information source;
referencing the at least one information source;
determining that the at least one information source comprises event information associated with the trigger event;
retrieving the event information;
analyzing the event information, wherein analyzing the event information comprises identifying an occurrence of the trigger event; and
performing the operation corresponding to the advertising campaign incident to identifying the occurrence of the trigger event.

2. The one or more computer-readable media of claim 1, wherein the at least one information source comprises a network site.

3. The one or more computer-readable media of claim 1, wherein the at least one information source comprises a database.

4. The one or more computer-readable media of claim 1, wherein the trigger event comprises at least one of an increase in spending power associated with a consumer population, a natural disaster, and a change in a value of shares of stock of a company.

5. The one or more computer-readable media of claim 1, wherein the event information comprises an event occurrence vote retrieved from the at least one information source, wherein the event occurrence vote comprises data associated with identifying an occurrence of the trigger event.

6. The one or more computer-readable media of claim 5, further comprising:
referencing a weighting factor corresponding to the at least one information source;
creating at least one weighted vote by associating the at least one weighting factor with the event occurrence vote retrieved from the at least one information source; and
analyzing the at least one weighted vote to determine whether the at least one weighted vote identifies an occurrence of the trigger event.

7. The one or more computer-readable media of claim 1, wherein performing the operation comprises at least one of initiating the advertising campaign and modifying a trigger element associated with the advertising campaign.

8. The one or more computer-readable media of claim 7, wherein initiating the advertising campaign comprises referencing the campaign trigger definition to determine a duration associated with the advertising campaign.

9. The one or more computer-readable media of claim 7, wherein modifying a trigger element associated with the advertising campaign comprises modifying the identification of the trigger event.

10. One or more computer-readable media having computer-executable instructions embodied thereon for performing a method of managing an advertising campaign, the method comprising:
referencing a campaign trigger definition corresponding to an advertising campaign, the campaign trigger definition comprising an identification of a trigger event, wherein the campaign trigger definition further comprises identification of an operation associated with the advertising campaign to be performed incident to identifying an occurrence of the trigger event;
retrieving an event occurrence vote from each of one or more information sources, wherein the event occurrence vote comprises data associated with identifying an occurrence of the trigger event;
referencing a weighting factor corresponding to each of the one or more information sources;
creating one or more weighted votes by associating each weighting factor with the event occurrence vote retrieved from the information source corresponding to the weighting factor;
analyzing the one or more weighted votes to determine whether the one or more weighted votes identify an occurrence of the trigger event; and
performing the operation incident to determining that the one or more weighted votes identify an occurrence of the trigger event.

11. The one or more computer-readable media of claim 10, wherein the weighting factor corresponding to each of the one or more information sources is established based on a source classification associated with each of the one or more information sources.

12. The one or more computer-readable media of claim 11, wherein a first information source is associated with a first source classification, the first source classification comprising an indication that the first source comprises an authoritative source, wherein an authoritative source is a source from which an event occurrence vote identifies an occurrence of the event.

13. The one or more computer-readable media of claim 12, wherein analyzing a first weighted vote corresponding to the first source comprises determining that the first weighted vote identifies an occurrence of the trigger event.

14. The one or more computer-readable media of claim 13, wherein a second information source is associated with a second source classification, the second source classification comprising an indication that an event occurrence vote retrieved from the second source comprises a user-generated event occurrence vote.

15. The one or more computer-readable media of claim 14, wherein analyzing a second weighted vote corresponding to the second source comprises determining that the second weighted vote does not identify an occurrence of the trigger event.

16. The one or more computer-readable media of claim 15, further comprising:
retrieving an event occurrence vote from a third information source incident to determining that the second weighted vote does not identify an occurrence of the trigger event;
referencing a weighting factor corresponding to the third information source;
creating a third weighted vote by associating a third weighting factor with the event occurrence vote retrieved from the third information source; and
analyzing the second and third weighted votes to determine whether the second and third weighted votes identify an occurrence of the trigger event.

17. The one or more computer-readable media of claim 10, wherein performing the operation comprises at least one of initiating the advertising campaign and modifying the advertising campaign.

18. A computer system capable of causing an advertisement to be provided to a presentation device, the computer system comprising a computer storage medium having a plurality of computer software modules embodied thereon, the computer software modules being executed by a processor and comprising:
a graphical interface that allows an advertiser to configure a campaign trigger definition associated with an advertising campaign, the campaign trigger definition comprising an identification of a trigger event, wherein the campaign trigger definition further comprises identification of an operation associated with the advertising campaign to be performed incident to identifying an occurrence of the trigger event;
a crawler that retrieves event information associated with the trigger event from one or more information sources;
an analysis module that analyzes the event information to determine whether an occurrence of the trigger event is identified by the event information; and
a delivery engine that causes an advertisement corresponding to the advertising campaign to be displayed via the presentation device.

19. The computer system of claim 18, wherein the event information comprises an event occurrence vote retrieved from each of one or more information sources, wherein the event occurrence vote comprises data associated with identifying an occurrence of the trigger event.

20. The computer system of claim 19, wherein the analysis module comprises:
a weighting component that creates one or more weighted votes by associating a weighting factor corresponding to each information source with an event occurrence vote retrieved from the information source corresponding to the weighting factor; and
an event detection component that analyzes the one or more weighted votes to determine whether the one or more weighted votes identify an occurrence of the trigger event.
